(19) United States
(12) Patent Application Publication
(10) Pub. No.: US 2008/0086741 A1
(43) Pub. Date: Apr. 10, 2008

(54) Audience commonality and measurement

(75) Inventors: Konrad Feldman, San Francisco, CA (US); Paul Sutter, San Francisco, CA (US)

Correspondence Address: FERNANDEZ & ASSOCIATES LLP, 1047 EL CAMINO REAL, SUITE 201, MENLO PARK, CA, 94025, US

(73) Assignee: Quantcast Corporation, San Francisco, CA (US)

(21) Appl. No.: 11/784,299

(22) Filed: Apr. 6, 2007

Related U.S. Application Data
(60) Provisional application No. 60/851,027, filed on Oct. 10, 2006.

(51) Int. Cl. H04H 9/00; H04N 7/16; H04H 60/33; H04H 60/45

(52) U.S. Cl. 725/13; 725/9; 725/11

(57) ABSTRACT

Audience commonality metrics for characterizing the relationship between networked media channels based on audience overlap of identified visitor entities and their related media consumption histories. Audience commonality metrics may be scalars or multi-dimensional metrics and may take into account and/or be used in conjunction with data related to on- or off-network media channels, on- or off-network activities, sociographics and/or demographics. The current invention may be used in the design of networked advertising campaigns, identification of new or unusual market segments and/or valuation of media buys. A system according to the current invention comprises access to a configuration, an input for receiving audience commonality data, an audience commonality metrics engine and an output for providing calculated audience commonality metrics. Data related to identified visitor entities may be received, determined and/or inferred from resources such as a cookie, log file, sniffer, firewall, proxy server, client agent, tracking pixel and/or tool

### CROSS-REFERENCE TO RELATED APPLICATIONS

This application is a conversion of and claims priority from U.S. Provisional application No. 60/851,027 filed on Oct. 10, 2006, entitled “Affinity Comprehension and Measurement”, herein incorporated by reference.

### FIELD OF INVENTION

The invention relates to methods and systems for characterizing networked media channels.

### BACKGROUND OF INVENTION

Online advertising spend is anticipated to exceed $20 billion in 2007 and is rapidly becoming an essential channel for advertisers to reach their target market. At the forefront of the emergence of online advertising has been lower-funnel, intent focused advertising designed to elicit a direct response, such as the keyword based advertising model. The success of this model can be attributed in large part to the simplicity of the planning, execution and measurement cycle and the tight alignment of the targeting and measurement dimensions, namely keywords and clicks. Furthermore, keyword based advertising has allowed direct response advertisers to operate successfully despite the massive fragmentation of online media audiences.

In the US over $70 billion dollars is spent annually on television advertising, the majority of which is upper funnel advertising designed to inform, education and influence consumers, but to not necessarily elicit an immediate or direct response. This form of advertising has not yet had the same level of growth online as direct response advertising, in large part due to the difficulty in selecting favorable websites or online channels to run a campaign given the massive diversity of options. Furthermore, in some cases, targeting audiences with esoteric lifestyles can be difficult using standard targeting schemes employing typical demographic and/or psychographic criteria to define a target audience.

### SUMMARY OF INVENTION

According to the current invention, the relationship between sets of networked media channels may be characterized by calculating audience commonality metrics, based at least in part on the audience overlap of identified visitor entities and their related media consumption histories.

In some examples according to the current invention, audience commonality metrics may be simple scalars, ratings or multi-dimensional metrics. Optionally, audience commonality metrics may be categorized, sorted and/or ordered. In some cases, audience commonality metrics may take into account and/or be used in conjunction with a variety of different resources such as, but not limited to, data related to off-network media channels, data related to on-network activities, data related to off-network activities, sociographic data, psychographic data and/or demographic data.

According to some examples of the current invention, identified visitor entities may represent individuals or groups. In some examples of the current invention, anonymity may be preserved as identification may not necessarily link an identified visitor entity (and related media consumption history) to personally identifiable information such as a name and/or physical address.

Some examples of the current invention may be used to help design online advertising campaigns. The current invention may be used to identify clusters of media channels with common visitor audiences which may or may not conform to known demographic groupings; similarly, new, esoteric or unusual market segments may be identified and/or characterized using audience commonality metrics. In some examples according to the current invention, market segments may be described by characteristic networked media channels. In some examples according to the current invention, the identification of clusters of media channels may be used to create custom advertising networks for advertisers based on their own arbitrary specification of desirable audience characteristics and also by publishers seeking to corral additional suitable inventory to sell along side their own audiences.

A system according to the current invention comprises access to a configuration, an input for receiving audience commonality data, an audience commonality metrics engine and an output for providing calculated audience commonality metrics. According to various examples of the current invention, audience commonality data such as media consumption histories, data related to identifying visitor entities, and/or data related to identified visitor entities may be received, determined and/or inferred from one or more resources such as, but not limited to, a cookie, a log file, a sniffer log, a firewall log, a proxy server log, a client agent, a tracking pixel and/or a toolbar.

### BRIEF DESCRIPTION OF DRAWINGS

FIG. 1 illustrates an example method according to the current invention for characterizing sets of media channels with an audience commonality metric.

FIG. 2 illustrates an example set of audience commonality metrics.

FIG. 3 illustrates another example set of audience commonality metrics.

FIG. 4 illustrates an example method for calculating a simple audience commonality metric for a single object media channel (Website A) and a single subject media channel (Website B).

FIG. 5 illustrates an example system according to the current invention for characterizing the relationship between multiple networked media channels by calculating audience commonality metrics.

### DETAILED DESCRIPTION OF THE INVENTION

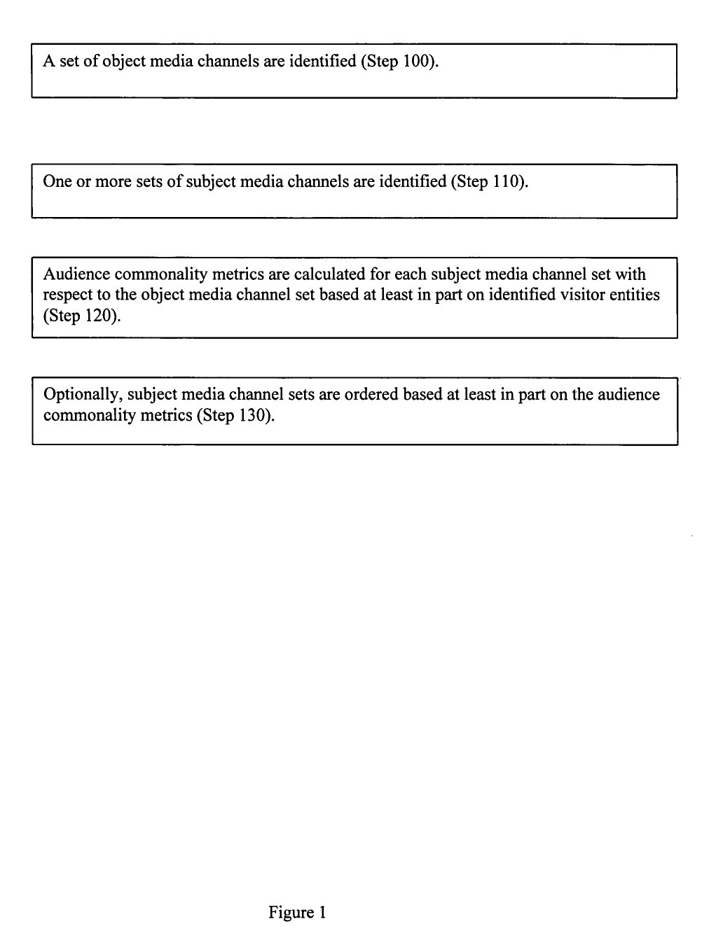

FIG. 1 illustrates an example method according to the current invention for characterizing sets of networked media channels with an audience commonality metric. The method begins when a set of object media channels are identified (Step 100). A networked media channel is any form of media delivery over a network for which an observation of consumption of that media can be made or inferred. Examples include, but are not limited to, a web site, a web page, a TV show, a video stream and a music stream. In some examples, consumption events may comprise simple exposure to media whereas in other examples, consumption events may incorporate more complex and/or compound activities such as, but not limited to, pressing a button, viewing a portion of a video, submitting a registration or completing the online purchase of an item. In some cases, media channels may comprise networked advertising destinations, commercial, non-commercial, non-profit, not-for-profit, educational, personal and/or governmental media channels which may be accessed through one or more intermittent and/or persistent networks such as, but not limited to, an intranet, the Internet, a local area network (LAN), a phone network, a cellular phone network and/or a cable television network.

According to the current invention, audience commonality metrics are calculated for multiple sets of subject media channels with respect to a set of object media channels; an audience commonality metric characterizes overlap in audiences between a set of subject media channels and a set of object media channels, based on identified visitor entities. A set of subject media channels may comprise one or more media channels; similarly, a set of object media channels may comprise one or more media channels. In some cases, the overlap between a set of subject media channels and a set of object media channels represents the audience in common with all of the media channels in the set of subject channels and all of the media channels in the set of object media channels. However in other examples, an audience commonality metric may be designed to reflect a partial overlap in audience for a set of object media channels and sets of subject media channels. For example, the audience commonality metric may be designed to reflect the audience overlap with respect to two out of three object media channels from the set of object media channels with respect to each set of subject media channels; similarly, in some cases, only a subset of each set of subject media channels may be considered when calculating audience commonality metrics.

In some cases, the audience commonality metric may incorporate the use of and/or be used in conjunction with considerations such as, but not limited to, time windows, date windows, geographic location, demographic data, sociographic data and/or considerations based on a history of visitor entity activity. In some cases, the audience commonality metric may incorporate the use of and/or be used in conjunction with data related to un-networked or off-network activities such as, but not limited to, exposure related to non-networked media channels, in-store purchase history and exposure to newspaper, magazine, print, billboard advertisements and/or other non-networked advertisements.

In some examples according to the current invention, a visitor entity may represent an individual person. However, in some cases, a visitor entity may represent a user, a registered user, a licensed seat and/or a logical agglomerative grouping or subset thereof such as, but not limited to, a business, a family, household, social network, team and/or department. Identifying a visitor entity means associating a specific visitor entity with a media consumption history. In some cases, the identification results in a unique, exact and verifiable match. However, in some cases, identification may or may not be verifiably unique or correct; for example, in some examples according to the current invention, identification may be assumed or inferred or the process of identification may be imperfect. In some cases, identifying a visitor entity may mean associating a media consumption history with an actual person or a logical agglomerative grouping or subset thereof; however, in other cases, identifying a visitor entity may mean associating a media consumption history with an identifier such as, but not limited to, a globally unique identifier, a locally unique identifier, a presumably unique identifier, a registration number, a name, a login name, a user name, a user ID and/or a license number. In some cases, identification may still preserve anonymity in that it does not necessarily link a visitor entity (and/or the related consumption history) to a person's name, physical address, personally identifiable information and/or information which may be considered sensitive such as, but not limited to, a social security number.

A media consumption history documents media consumption events associated with a visitor entity. In some cases, a media consumption history may or may not be limited to a particular time window. In some cases, the media consumption may be observed through direct examination such as, but not limited to, electronic monitoring. In some cases, some record of the media consumption is used to count, identify or validate visitor entities. In some examples according to the current invention, a media consumption history may be determined and/or inferred from one or more resources such as, but not limited to: a cookie, a log file, a sniffer log, a firewall log, a proxy server log, a client agent, a tracking pixel and/or a toolbar; in some cases, a software program such as, but not limited to, a browser, may report information used to determine and/or infer media consumption associated with a visitor entity through the use of a tracking pixel, an embedded script, an entity tag (ETag) and/or a shared object. Note that the population of identified visitor entities used in various audience commonality metric calculations may be related to the sources of media consumption history data. For example, if a sniffer log at a particular Internet Service Provider (ISP) is the sole source of media consumption history data, the population of identified visitor entities used in the calculation of an audience commonality metric would be limited to users of that particular ISP. Various data source and data collection techniques may result in different populations of identified visitor entities, which may impact the audience commonality metric results.

In some examples according to the current invention, criteria for characterizing object and/or subject consumption events may be defined. For example, an object consumption event may be characterized to determine which entities will contribute to the audience commonality metric as visitor entities; entities meeting the object consumption event criteria would contribute to the calculation of the audience commonality metric whereas entities which do not meet the object consumption criteria would not be considered unique visitor entities and would not be considered part of the audience in an audience commonality metric calculation. For example, with an object consumption event criterion of viewing a full webpage, visitors to that webpage who have not downloaded the entire webpage would not be considered part of the audience. Similarly, a subject consumption event criterion could be used to determine which visitor entities could contribute to the audience commonality metric. In some cases, object and subject consumption event criteria may or may not be the same; furthermore, in some cases, object and/or subject consumption event criteria may be set per media channel. In another example according to the current invention, consumption events may be scored according to some function; for example, a consumption event score may take into account the difference between a visitor entity watching a complete video stream and a visitor entity watching only half of a video stream. Consumption event scores may be subsequently used for a variety of purposes such as, but not limited to, categorization.

In some examples according to the current invention, an audience commonality metric may comprise a simple scalar; however, in other examples according to the current invention, an audience commonality metric may comprise a multi-dimensional profile, a category and/or a rating. In some cases, the audience commonality metric may be calculated according to a fixed, partially configurable or fully configurable algorithm.

The method continues when one or more sets of subject media channels are identified (Step 110). A set of subject media channels comprises one or more media channels.

The method continues when audience commonality metrics are calculated for each subject media channel set with respect to the object media channel set based at least in part on identified visitor entities (Step 120). In some cases, audience commonality metrics may be newly and fully calculated in this step. However, in other examples according to the current invention, this step may or may not comprise updating an audience commonality metric or some portion of an audience commonality metric; for example, this may be useful in cases where previous data, intermediate calculations and/or previously calculated audience commonality metrics are accessible.

Optionally, the method continues when the subject media channel sets are ordered based at least in part on the audience commonality metrics (Step 130). For example, in some cases, the audience commonality metric may be a simple scalar and subject media channels sets may be ranked in descending or ascending order based on their audience commonality metric values with respect to an object media channel set. In some cases, subject media channels may be categorized in addition to and/or instead of ranking. Examples of categories include, but are not limited to, market category and/or type of media channel. However, in some examples, the audience commonality metric may be multi-dimensional. For example, a multi-dimensional audience commonality metric may reflect additional information such as, but not limited to, audience commonality metrics with respect to demographic subgroups, object media consumption event criteria and/or subject media consumption event criteria; in this case, the step of ordering may be complex. In some cases, a multi-dimensional audience commonality metric may reveal the effect of various variables on the audience overlap; audience overlap may fluctuate with respect to many variables such as, but not limited to, time-of-day, day of the week, time zone and data sources. In some cases, visitor entities may be further characterized, categorized and/or scored; the calculation of audience commonality metric values may be dependent, in part, on the visitor entity characterization, categorization and/or score. For example, some visitor entities may be identified as high value visitor entities, and related audience commonality metrics may be calculated to reflect the common traffic associated with identified high value common visitor entities. For example, a high value common visitor entity may be a common visitor entity with a favorable demographic profile and/or a common visitor entity who has participated in a favorable outcome such as the completion of an online purchase.

In some examples according to the current invention, audience commonality metrics may further reflect a measure of the number of common visitor entities compared to the expected number of common visitor entities. In some cases, the expected number of common visitor entities may be estimated and/or based on group statistics; in some cases, assumptions may be made such as, but not limited to, estimating the expected number of common visitor entities cased on group statistics, assuming that channel visitation is conducted on an independent random basis.

Furthermore, in some cases, the subject media channels sets may be sorted, ordered, ranked, categorized and/or selected based on additional sorting and/or ranking criteria. Examples of additional criteria include, but are not limited to: an audience commonality metric range, audience commonality metric maximum, audience commonality metric minimum, price of a media buy related to a subject media channel, availability of a media buy related to a subject media channel and/or demographics related to a subject media channel.

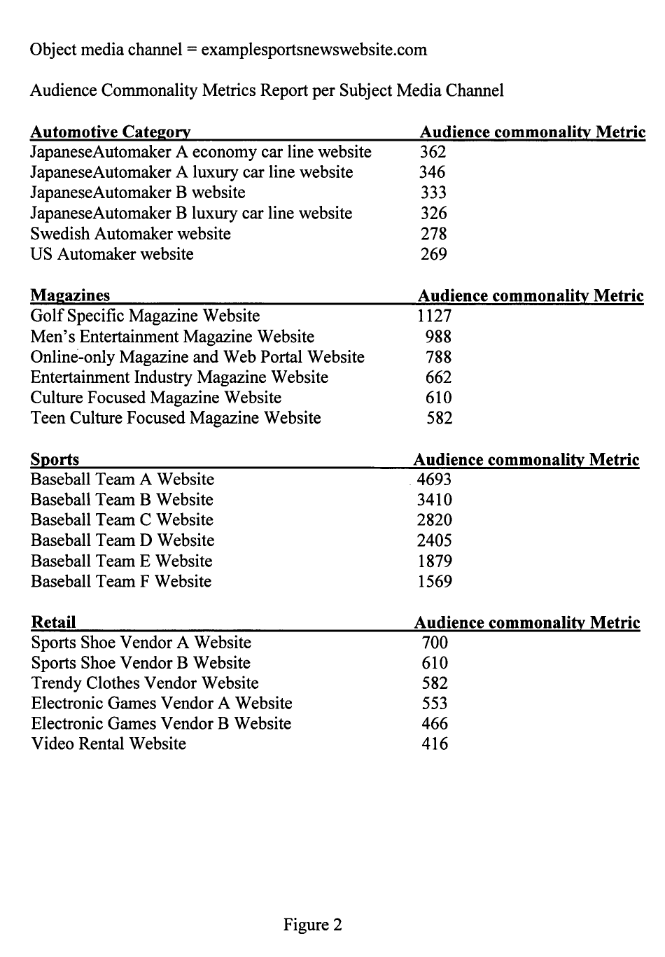

FIG. 2 illustrates an example set of audience commonality metrics. In this example, the set of object media channels comprises a single media channel, the website “examplesportsnewswebsite.com”. Audience commonality metrics were calculated for many individual subject websites. In this example, each individual website corresponds to a subject media set comprising a single media channel. In this example, the audience commonality metrics are simple scalars. In this example, individual subject media channels (such as “Japanese Automaker B website” and “Culture Focused Magazine Website”) are sorted based on the value of the index and also grouped into clusters based on market segment (such as “Automotive Category” and “Sports”) in order to ease interpretation of the results. However, according to the current invention, a variety of other optional display configurations are envisioned.

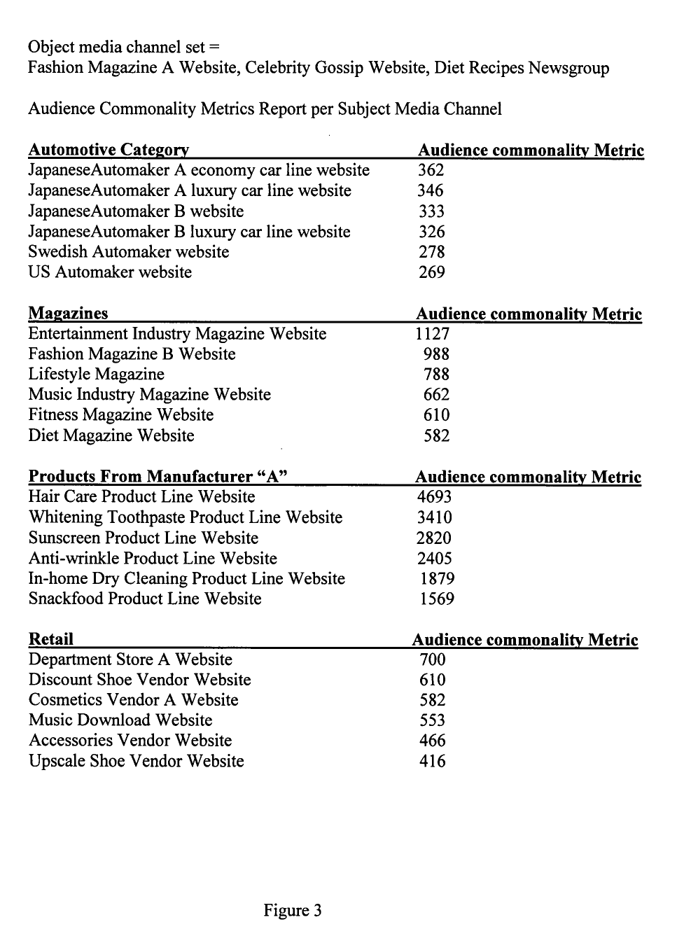

FIG. 3 illustrates another example set of audience commonality metrics. In this example, the set of object media channels comprises three media channels: Fashion Magazine A Website, Celebrity Gossip Website and the Diet Recipes Newsgroup. Audience commonality metrics were calculated for many individual subject websites. In this example, each individual website corresponds to a subject media set comprising a single media channel. For this example, the audience overlap criteria required visitor entities to have visited the subject media channel of interest as well as at least two of the three media channels in the object media channel set in order to contribute to the audience overlap. For this example, the resulting audience commonality metrics for the subject websites have been arranged by example market segments such as “Automotive Category” and “Sports” and also ordered in descending audience commonality value per market segment.

The current invention may be used to create a market segment map of the Internet. For example, some examples of the current invention may be used to identify popular media channels for standard media channel segments. For example, a market segment may be characterized as “Hockey Enthusiasts” and one or more websites or webpages thought or known to be popular with “Hockey Enthusiasts” may be selected as an object media channel set. In some cases, the selection of one or more object media channels to characterize a particular market segment may be based on statistics, demographics, intuition and/or expert advice, resulting in the selection of a set of one or more characteristic media channels. By calculating audience commonality metrics for a broad variety of subject media channels with respect to the object media channel set, an Internet “Hockey Enthusiasts” market segment may be identified and characterized.

In some examples according to the current invention, audience commonality metrics may be used to focus on new, esoteric or unusual market segments. For example, by selecting a set of object media channels to characterize a newly defined market segment and then using a comprehensive set of subject media channels in conjunction with the current invention, the browsing habits of a new, esoteric or unusual market segment may be documented. In some cases, selecting a set of one or more object media channels to characterize a target market may be a natural way for advertisers to envision a desirable target market.

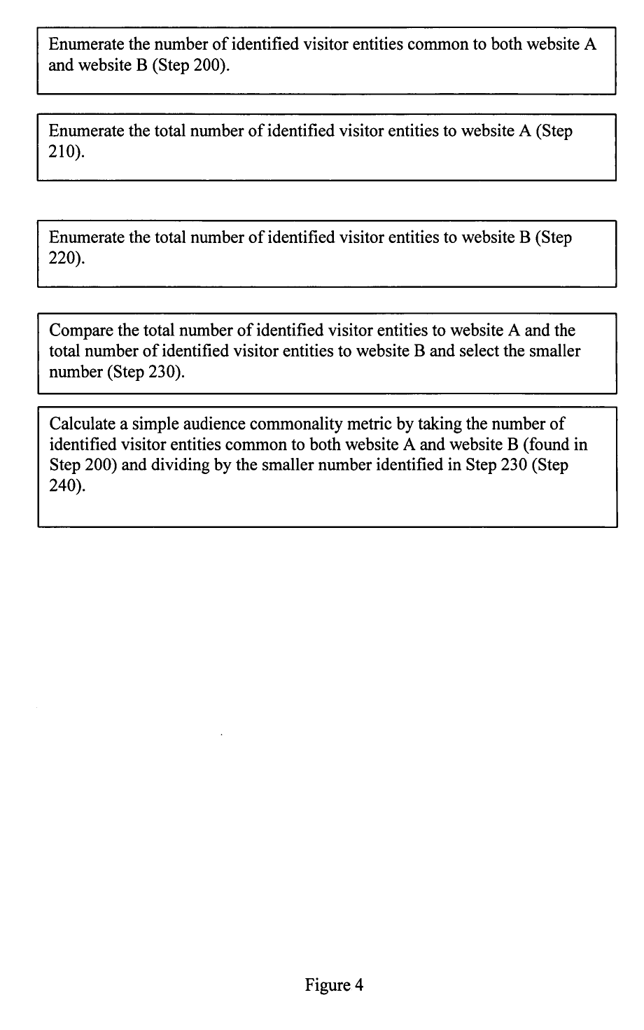

Audience commonality metrics may be calculated in a variety of ways. FIG. 4 illustrates an example method for calculating a simple audience commonality metric for a single object media channel (Website A) and a single subject media channel (Website B). The method begins when the number of identified visitor entities common to both website A and website B are enumerated (Step 200). Enumerate the total number of identified visitor entities to website A (Step 210). Enumerate the total number of identified visitor entities to website B (Step 220). Compare the total number of identified visitor entities to website A and the total number of identified visitor entities to website B and select the smaller number (Step 230). Calculate a simple audience commonality metric by taking the number of identified visitor entities common to both website A and website B (found in Step 200) and dividing by the smaller number identified in Step 230 (Step 240). Note that Step 240 illustrates a simple example of an audience commonality metric. However, according to the current invention, other simple or complex algorithms may be used. For the example given in Step 240, an audience commonality metric of “1” (one) would indicate that all of the visitors to the lower traffic website also visited the higher traffic website; an audience commonality metric of “0” (zero) would indicate that there are no visitors common to both website A and website B.

Many different types of audience commonality metrics are possible. For example, in some cases, an audience commonality metric (or an element of a multi-dimensional audience commonality metric) may be implemented as a rating which may improve (or deteriorate) with increasing audience overlap. In some examples according to the current invention, commonality metrics may take into account both overlap and exclusivity; for example an audience commonality metric implemented as a rating may be designed to rate audience overlap between media channel A and media channel B, excluding contributions from identified visitor entities common to media channel A, media channel B and media channel C.

According to the current invention, the audience commonality metrics may be output from the current invention. In some cases, they may be stored in one or more external databases. For example, in some cases, audience commonality metrics may be stored in a centralized database, a distributed database, cookies and/or a file system. However, in some cases, some audience commonality metrics may be stored in one or more files or databases internal to the current invention and output from the system in response to queries or requests. In other examples, audience commonality metrics may be output from the current invention in various forms such as, but not limited to, a datastream, a report or a message.

According to the current invention, audience commonality metrics may be used to plan and/or model proposed advertising campaigns. For example, according to the current invention, an advertiser may characterize their target audience in terms of one or more characteristic media channels. For example, an advertiser selling sunscreen may say that their target audience would be a visitor to a particular surfing website. By identifying and/or selecting networked advertising destinations with favorable audience commonality metrics with respect to the characteristic media channel, the advertiser may plan and/or model a proposed advertising campaign. Note that in some examples according to the current invention, the characteristic media channel is not required to be an advertising destination. In this case, an advertiser may characterize their target audience by identifying one or more media channels which it cannot use as an advertising destination, for whatever reason, and possibly identify an accessible advertising destination for their advertisement. For example, an advertiser may wish to reach the viewers of a website that does not accept advertising; by identifying networks with favorable audience commonality metrics, the advertiser may still be able to reach their target audience. A media channel may not be available as a networked advertising destination to an advertiser for a variety of other reasons such as, but not limited to, inventory exhaustion and prohibitive pricing structures.

According to the current invention, audience commonality metrics may be used to analyze and or value networked advertising destinations with respect to a potential advertiser. For example, a potential advertiser could be characterized with one or more characteristic media channel. By accessing audience commonality metrics for the characteristic media channel(s) with respect to one or more networked advertising destinations related to the advertising opportunities and matching potential advertising opportunity purchasers with networked advertising destinations based on audience commonality metrics, a publisher may be able to make strong recommendations to a current or potential client. In some cases, the same information may be used to guide or set pricing for a particular networked advertising destination with respect to a particular customer.

According to the current invention, audience commonality metrics may be used to analyze, advertising inventories and/or media buys; in some cases, audience commonality metrics may be used to establish recommendations for their usage. For example, a large corporation with multiple advertising campaigns associated with multiple products may analyze their media buys to determine which products would benefit most from their existing advertising inventory. For example, each product might be characterized with one or more characteristic media channels. In some cases, an improved media buy usage plan may be constructed based on using audience commonality metrics to analyze the media buy's networked advertising destinations with respect to the characteristic media channel(s). Similarly, an advertiser may create a list of potential advertising destinations of interest and analyze the list using audience commonality metrics with respect to one or more media channels such as, but not limited to, advertising destinations associated with previously successful campaigns and/or media channels with attractive demographics.

According to the current invention, networked advertising destinations associated with existing advertising campaigns may be analyzed using audience commonality metrics and new advertising outlets may be identified for consideration. For example, the top advertising destinations associated with a networked advertising campaign could be identified and media channels with favorable audience commonality metrics with respect to the top networked advertising destinations could be identified for consideration as new media channels for the advertising campaign.

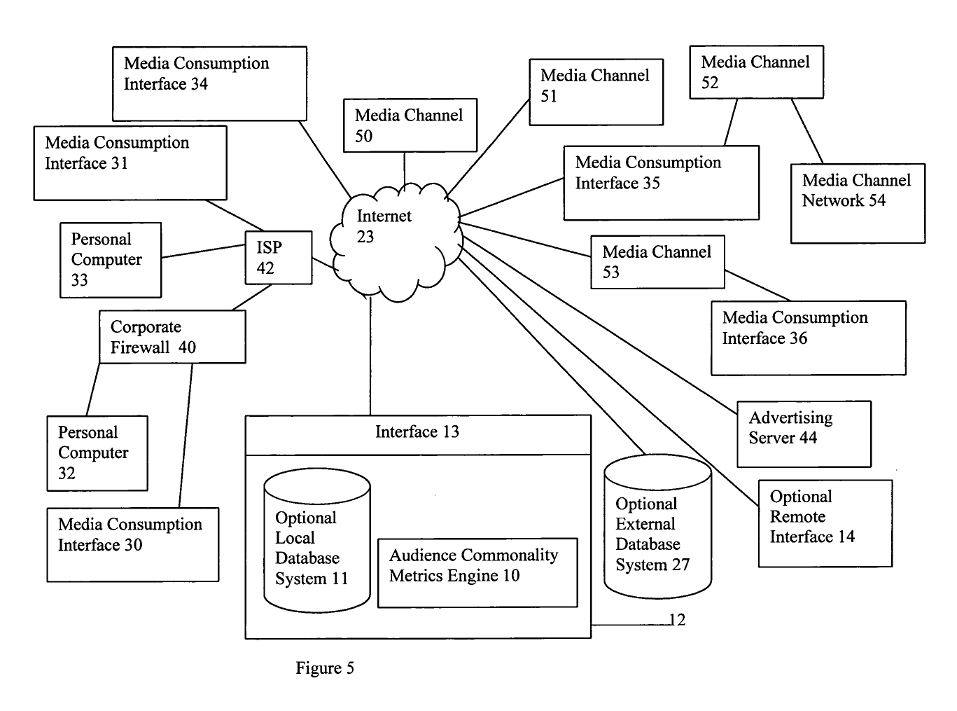

FIG. 5 illustrates an example system 12 according to the current invention for characterizing the relationship between multiple networked media channels by calculating audience commonality metrics. According to the current invention, the system calculates audience commonality metrics per set of subject media channels with respect to a set of object media channels using audience commonality data and an algorithm. A system for characterizing the relationship between multiple networked media channels may comprise hardware, firmware and/or software; furthermore, a system according to the current invention may be localized or distributed across multiple systems and/or locations. A system according to the current invention comprises access to a configuration, an input for receiving audience commonality data, an audience commonality metrics engine and an output for providing calculated audience commonality metrics. Optionally, the current invention may further comprise one or more database systems and/or be coupled to one or more external database systems.

According to the current invention, a configuration comprises configuration data identifying a set of one or more object media channels; in addition, a configuration comprises configuration data identifying multiple sets of subject media channels wherein each set of subject media channels comprises one or more subject media channels. In some cases, the configuration may comprise additional information such as, but not limited to, an audience commonality metric algorithm and/or algorithm parameters. For the system illustrated in FIG. 5, the configuration is stored in optional local database system 11. However, in other examples according to the current invention, some or all of a configuration may be stored internal to and/or external to a system for characterizing the relationship between multiple networked media channels. In some cases, the configuration may be locally, remotely and/or automatically reconfigurable.

According to the current invention, a system for characterizing the relationship between multiple networked media channels comprises an input for receiving audience commonality data. In the example illustrated in FIG. 5, interface 13 acts as an input for receiving audience commonality data; in addition, interface 13 is used as an output for providing calculated audience commonality metrics. In other examples according to the current invention, the input and output may or may not be implemented in the same element. In some examples according to the current invention, multiple inputs, multiple outputs and/or multiple interfaces may be implemented; in some cases, one or more inputs, outputs and/or interfaces may be single purpose (i.e. an input for receiving audience commonality data only) or multi-purpose (i.e. an input and/or an output for handling one or more types of data).

Audience commonality data is data for correlating identified users with media consumption events related to media channels. In some cases, the current invention may receive partially processed audience commonality data such as, but not limited to, pre-processed audience commonality data wherein identified users are correlated with media consumption events related to media channels. However, in some cases, the current invention may receive unprocessed or partially processed data which requires additional processing and/or calculation in order to prepare it for use in conjunction with the audience commonality metrics engine 10. In some cases, data may require additional processing such as, but not limited to, reformatting. In some cases, audience commonality data may be received, collected, requested and/or retrieved from two or more sources; in some cases, subsequent operations to retrieve additional data, cross-reference, correlate and/or join data from one or more sources may be required.

A system for characterizing the relationship between multiple networked media channels comprises an output for providing calculated audience commonality metrics. In some examples according to the current invention, calculated audience commonality metrics may be stored in one or more optional databases. Referring to the example illustrated in FIG. 5, optional local database system 11 or optional external database system 27 could be used to store calculated audience commonality metrics; in these examples, the output may be provided in response to interactive, scheduled and/or pre-formatted database queries. In some examples, calculated audience commonality metrics may be exported through an output from the current invention in one or more formats such as, but not limited to, an output data stream or file.

In some cases, the system for characterizing the relationship between multiple networked media channels may be locally and/or or remotely accessed for one or more purposes such as, but not limited to: system configuration, algorithm configuration, monitoring, reporting, maintenance, query submission and/or data retrieval. A variety of techniques may be used to access and/or configure the system according to the current invention such as, but not limited to, programmatic configuration and/or graphical user interface driven configuration. For example, in FIG. 5, Optional Remote Interface 14 may be used to remotely access the audience commonality metrics calculator 10 in order to configure the algorithm via the Internet 23.

According to the current invention, audience commonality data for correlating identified users with media consumption events related to media channels may be collected from one or more resources. For example, referring to FIG. 5, cookies, data or files stored on media consumption interfaces 30, 31, 34, 35, 36 and/or personal computers 32 and 33 could be used, at least in part, to provide data for the calculation of audience commonality metrics. In other examples, various logs or databases may be used to provide data used in calculating audience commonality metrics; for example, data for calculating audience commonality metrics may be provided by systems such as a corporate firewall 40, an Internet Service Provider Server 42 and/or an advertising Server 44. In some cases, scripts, executables, tags and/or tracking pixels may be used to collect data used in calculating audience commonality metrics. In some cases, multiple types of resources and/or collection techniques may be used in conjunction with the current invention.

The order of the steps in the foregoing described methods of the invention are not intended to limit the invention; the steps may be rearranged.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

What is claimed is:

1. A method of characterizing multiple networked media channels by calculating audience commonality metrics, the method comprising the steps of:
identifying a set of one or more object media channels;
identifying multiple sets of subject media channels wherein each subject media channel set comprises one or more subject media channels; and,
calculating audience commonality metrics for each set of subject media channels wherein the step of calculating audience commonality metrics for one set of subject media channels comprises the steps of:
identifying visitor entities;
accessing media consumption histories associated with visitor entities; and,
assessing the degree of audience overlap between the set of object media channels and the subject media channels based at least in part on the identified visitor entities and their related media consumption histories.

2. The method of claim 1 wherein:
audience overlap requires visitor entities common to every media channel within the one set of subject media channels and all object media channels within the set of object media channels.

3. The method of claim 1 wherein:
audience overlap requires visitor entities common to every media channel within the one set of subject media channels and a configurable number of the object media channels within the set of object media channels.

4. The method of claim 1 wherein:
the step of assessing the degree of audience overlap comprises the step of comparing the number of identified visitor entities compared to the expected number of identified visitor entities.

5. The method of claim 1 wherein:
an audience commonality metric comprises a scalar value.

6. The method of claim 1 wherein:
an audience commonality metric comprises a multi-dimensional profile.

7. The method of claim 1 wherein:
an audience commonality metric comprises a category.

8. The method of claim 1 further comprising the step of:
storing at least some audience commonality metrics in a database.

9. The method of claim 8 wherein:
the database is selected from the list of:
a monolithic database, a distributed database, a database of distributed files and cookies.

10. The method of claim 1 wherein:
at least one set of media channels comprises at least one networked advertising destination.

11. The method of claim 1 wherein:
at least one set of media channels comprises a pair of networked advertising destinations.

12. The method of claim 1 wherein:
a media channel is selected from the list of: a website, a webpage, a video stream and a music stream.

13. The method of claim 1 wherein:
a visitor entity may represent a group of individuals forming a logical agglomerative grouping or a subset thereof.

14. The method of claim 13 wherein:
a logical agglomerative grouping or subset thereof is selected from the list of: a business, an organization, a department, a family, a social network and a household.

15. The method of claim 1 wherein:
a visitor entity comprises a visitor entity selected from the list of: a globally unique visitor entity, a locally unique visitor entity or a presumably unique visitor entity.

16. The method of claim 1 further comprising the step of:
identifying media channel market segments by selecting groups of media channels based at least in part on audience commonality metrics.

17. The method of claim 16 wherein:
the step of identifying media channel market segments is based at least in part on additional data selected from the list of: demographic data, sociographic data, and psychographic data.

18. The method of claim 1 further comprising the step of:
ranking sets of subject media channels with respect to a set of object media channels based at least in part on audience commonality metrics.

19. The method of claim 18 wherein:
the step of ranking sets of subject media channels with respect to a set of object media channels based at least in part on additional data selected from the list of: demographic data, sociographic data, psychographic data and data related to off-network activity.

20. The method of claim 1 wherein:
the step of assigning an audience commonality metric comprises calculating an audience commonality metric with an algorithm.

21. The method of claim 20 wherein the algorithm is configurable.

22. A method for selecting a set of favorable networked advertising destinations in relation to a target audience comprising the steps of:
characterizing a target audience by identifying one or more characteristic media channels;
identifying a set of favorable networked advertising destinations by selecting networked advertising destinations with favorable audience commonality metrics with respect to one or more of the characteristic media channels wherein:
an audience commonality metric characterizes the extent of audience overlap between sets of media channels based on identified visitor entities and their related media consumption histories.

23. The method of claim 22 wherein:
the extent of commonality represents the measured extent of audience overlap.

24. The method of claim 22 wherein:
the extent of commonality represents the estimated extent of audience overlap.

25. The method of claim 22 wherein:
the extent of commonality represents the historical extent of audience overlap over a specified time period.

26. The method of claim 22 further comprising the step of prioritizing a set of favorable networked advertising destinations based on one or more criteria selected from the list of:
audience commonality metric range, audience commonality metric maximum, audience commonality metric minimum, price of a media buy related to a favorable networked advertising destination, availability of a media buy related to a favorable networked advertising destination and demographics related to a favorable networked advertising destination.

27. The method of claim 22 further comprising the step of prioritizing a set of favorable networked advertising destinations based on audience characteristics.

28. A method for identifying media channels of interest based on the performance of a networked advertising campaign operating on multiple networked advertising destinations comprising the steps of:
identifying the top advertising destinations associated with the networked advertising campaign;
identifying favorable media channels comprising media channels with favorable audience commonality metrics with respect to the top networked advertising destinations;
accessing a history of media channels representing exposures to visitors who engaged the networked advertising campaign; and,
identifying media channels of interest by finding media channels common to both the set of favorable media channels and the history of media channels.

29. The method of claim 28 wherein the top advertising destinations associated with the networked advertising campaign comprise the networked advertising destinations with the highest ratio of favorable outcomes to campaign exposure

30. A method for analyzing a set of advertising opportunities associated with networked advertising destinations comprising the steps of:
characterizing one or more potential advertising opportunity purchasers for a networked advertising campaign by identifying one or more characteristic media channels per potential advertising opportunity purchaser;
accessing audience commonality metrics for one or more characteristic media channels with respect to one or more networked advertising destinations related to the advertising opportunities;
matching potential advertising opportunity purchasers for a networked advertising campaign with networked advertising destinations related to the advertising opportunities based on the audience commonality metrics.

31. The method of claim 30 wherein the owner of the advertising opportunities uses audience commonality metrics associated with one or more characteristic media channels to set the offer price of the advertising opportunities per potential advertising opportunity purchaser.

32. The method of claim 30 wherein the owner of the advertising opportunities uses audience commonality metrics associated with one or more characteristic media channels to identify one or more potential advertising opportunity purchasers.

33. A system for characterizing the relationship between multiple networked media channels by calculating audience commonality metrics, the system comprising:
access to a configuration comprising:
configuration data identifying a set of one or more object media channels; and,
configuration data identifying multiple sets of subject media channels wherein each set of subject media channels comprises one or more subject media channels;
an input for receiving audience commonality data for correlating identified users with media consumption events related to media channels;
an audience commonality metrics engine for calculating audience commonality metrics per set of subject media channels with respect to the set of object media channels using the audience commonality data and an algorithm; and,
an output for providing calculated audience commonality metrics.

34. The system of claim 33 wherein the algorithm is configurable.

35. The system of claim 33 further comprising a database for storing at least some calculated audience commonality metrics.

36. The system of claim 33 further comprising a database for storing at least some audience commonality data for correlating identified users with media consumption events related to media channels.

37. The system of claim 33 further comprising a database for storing at least some portion of the configuration.
